(19) United States
(12) Patent Application Publication
(10) Pub. No.: US 2008/0205536 A1
(43) Pub. Date: Aug. 28, 2008

(54) I/Q REGENERATION DEVICE OF FIVE-PORT NETWORK

(75) Inventors: Sang Yub Lee, Gyunggi-do (KR); Hyung Cheol Park, Daejeon (KR); Chang Soo Yang, Gyunggi-do (KR); Hak Sun Kim, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Samsung Electro-Mechanics Co., Ltd., GYUNGGI-DO (KR)

(21) Appl. No.: 12/037,537

(22) Filed: Feb. 26, 2008

(30) Foreign Application Priority Data
Feb. 27, 2007 (KR) 10-2007-19865

(51) Int. Cl. H04L 23/02

(52) U.S. Cl. 375/261

(57) ABSTRACT

There is provided an I/Q regeneration device of a five-port network which adopts a single-frequency continuous wave signal in place of a specific modulated signal such as a QPSK signal to estimate an I/Q regeneration parameter of the five-port network. The I/Q regeneration device of the five-port network including: a five-port network distributing an input signal as three signals and adding the three signals to first, second and third carrier signals, respectively to output first, second and third phase signals each having a phase different from one another; a power detection part detecting a power of each of the first, second and third phase signals from the five-port network to output first, second and third power detection signals; and a post-processing part restoring original data in response to the first, second and third power detection signals.

### CROSS-REFERENCE TO RELATED APPLICATIONS

This application claims the priority of Korean Patent Application No. 2007-19865 filed on Feb. 27, 2007, in the Korean Intellectual Property Office, the disclosure of which is incorporated herein by reference.

### BACKGROUND OF THE INVENTION

1. Field of the Invention

The present invention relates to an I/Q regeneration device of a five-port network applicable to a demodulator such as a receiver, and more particularly, to an I/Q regeneration device of a five-port network which employs a single-frequency continuous wave signal in place of a specific modulated signal such as a QPSK signal to estimate an I/Q regeneration parameter of a five-port network, thereby shortening estimation time of the I/Q regeneration parameter, expanding a range of applicable telecommunication systems and enabling demodulation using the five-port network.

2. Description of the Related Art

In general, a radio frequency (RF) receiver with a five-port network consumes much less power than an RF receiver using an active device and possesses broadband characteristics, thus suitably applicable to a structure of a software defined radio (SDR) receiver.

Currently, parameter estimation using QPSK data symbol is known as a way to employ the five-port network as a demodulator.

This conventional method using the QPSK data symbol has drawbacks in that the parameter estimation requires a great amount of time and the five-port network is applicable only to a QPSK modulation telecommunication system.

Meanwhile, the conventional five-port network presupposes using a modulated signal, particularly a quadrature phase-shift keying (QPSK) modulated signal to perform parameter estimation.

Here, the QPSK modulation is a quadrature modulation method which is generally and widely used. That is, to transmit data, a cosine component and a sine component of a carrier signal are used together and the data for transmission is divided into an in-phase channel and a quadature-phase channel by one bit, respectively to be passed through a pulse shaping filter (PSF).

Meanwhile, an orthogonal frequency division multiplexing (OFDM) signal or a continuous phase modulation (CPM) signal is of a quadrature modulation structure. However this quadrature modulation structure is different from QPSK in terms of the generation method of in-phase and quadrature-phase modulated waveforms during a symbol period.

Accordingly, to implement the five-port network with the conventional I/Q regeneration parameter estimation method, a modulator should be capable of performing QPSK modulation.

The conventional I/Q regeneration parameter estimation described above have following two problems.

First, the parameter estimation requires a considerable time and necessitates not only a preamble but also a data signal.

Second, the conventional method adopts orthogonality, which is a characteristic of a QPSK modulated signal. That is, the in-phase data and the quadrature-phase data are uncorrelated with each other. However, to utilize these characteristics, perfect recovery of carrier frequency/phase is required. That is, without carrier frequency/phase recovery, parameter estimation for I/Q regeneration is deteriorated.

Meanwhile, the carrier frequency/phase recovery disadvantageously necessitates a corrected I/Q regeneration parameter for regenerating an I/Q signal.

### SUMMARY OF THE INVENTION

An aspect of the present invention provides an I/Q regeneration device of a five-port network which adopts a single-frequency continuous wave signal in place of a QPSK data symbol to estimate an I/Q regeneration parameter of a five-port network, thereby shortening estimation time of an I/Q regeneration parameter.

According to an aspect of the present invention, there is provided an I/Q regeneration device of a five-port network including: a five-port network distributing an input signal as three signals and adding the three signals to first, second and third carrier signals, respectively to output first, second and third phase signals each having a phase different from one another; a power detection part detecting a power of each of the first, second and third phase signals from the five-port network to output first, second and third power detection signals; and a post-processing part restoring original data in response to the first, second and third power detection signals.

The I/Q regeneration device further includes: a filter part passing the first, second and third power detection signals therethrough and blocking noise except the first, second and third power detection signals.

The five-port network includes: a distributor distributing the input signal as the three signals; a polyphase filter phase-shifting a carrier signal differently from one another to generate the first, second and third carrier signals having different phases; and a multiple adder adding the three signals from the distributor to the first, second and third carrier signals from the polyphase filter, respectively to output the first, second and third phase signals having different phases.

The post-processing part includes: an initial parameter calculator calculating an initial I/Q regeneration parameter using phase shift of I/Q signals regenerated from the first, second and third power detection signals; a phase rotator phase-correcting the I/Q regeneration parameter from the initial parameter calculator to calculate a corrected I/Q regeneration parameter; and a parameter normalizer normalizing the corrected I/Q regeneration parameter from the phase rotator to calculate a final I/Q regeneration parameter.

The initial parameter calculator divides each of the I/Q signals regenerated from the first, second and third power detection signals into two factors according to phase shift, and calculates the initial I/Q regeneration parameter such that direct current offset is eliminated from the two factors.

The phase rotator phase-corrects the initial I/Q regeneration parameter using the I/Q regeneration parameter from the initial parameter calculator such that a long axis of an elliptical locus defined by the I/Q signals regenerated coincides with an X axis, and calculates the corrected I/Q regeneration parameter.

The parameter normalizer scales a regeneration parameter for one of an I value signal and a Q value signal out of the corrected I/Q regeneration parameter from the phase rotator and normalizes the regeneration parameter such that an I value has a maximum size identical to a maximum size of a Q value.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration view illustrating an I/Q regeneration device of a five-port network according to an exemplary embodiment of the invention;

FIG. 2 is an internal configuration view illustrating a five-port network according to an exemplary embodiment of the invention;

FIG. 3 is an internal configuration view illustrating a post-processing part according to an exemplary embodiment of the invention;

FIG. 4 is a locus diagram of a received signal inputted to a five-port network according to an exemplary embodiment of the invention;

FIG. 5 is a locus diagram of a received signal inputted to a post-processing part and I/Q signals regenerated from uninitialized I/Q regeneration parameters;

FIG. 6 is a locus diagram of I/Q signals regenerated by initial I/Q regeneration parameters calculated by an initial parameter calculator according to an exemplary embodiment of the invention;

FIG. 7 is a locus diagram of I/Q signals regenerated by corrected I/Q regeneration parameters corrected by a phase rotator according to an exemplary embodiment of the invention; and

FIG. 8 is a locus diagram of I/Q signals regenerated by I/Q regeneration parameters finally corrected by a parameter normalizer according to an exemplary embodiment of the invention.

### DETAILED DESCRIPTION OF THE PREFERRED EMBODIMENT

Exemplary embodiments of the present invention will now be described in detail with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the same reference signs are used to designate the same or similar components throughout.

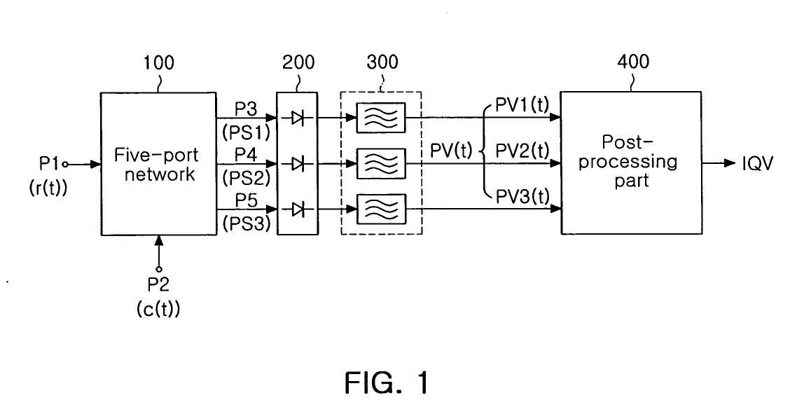

FIG. 1 is a configuration view illustrating an I/Q regeneration device of a five-port network according to an exemplary embodiment of the invention.

Referring to FIG. 1, the I/Q regeneration device of the five-port network of the present embodiment includes a five-port network 100, a power detection part 200 and a post-processing part 400. The five-port network 100 distributes an input signal (r(t)) as three signals and adds the three signals to first, second and third carrier signals (c1(t)), (c2(t)), and (c3(t)) having different phases, respectively to output first, second and third phase signals (PS1), (PS2), and (PS3) having phases different from one another. The power detection part 200 detects power of the first, second and third phase signals (PS1), (PS2), and (PS3) from the five-port network 100 to output first, second and third power detection signals. The post-processing part 400 recovers original data in response to the first, second and third power detection signals (PDV1), (PDV2), and (PDV3) from the power detection part 200.

Also, the I/Q regeneration device of the five-port network further includes a filter part passing the first, second and third power detection signals from the power detection part therethrough and blocking noise except the first, second and third power detection signals.

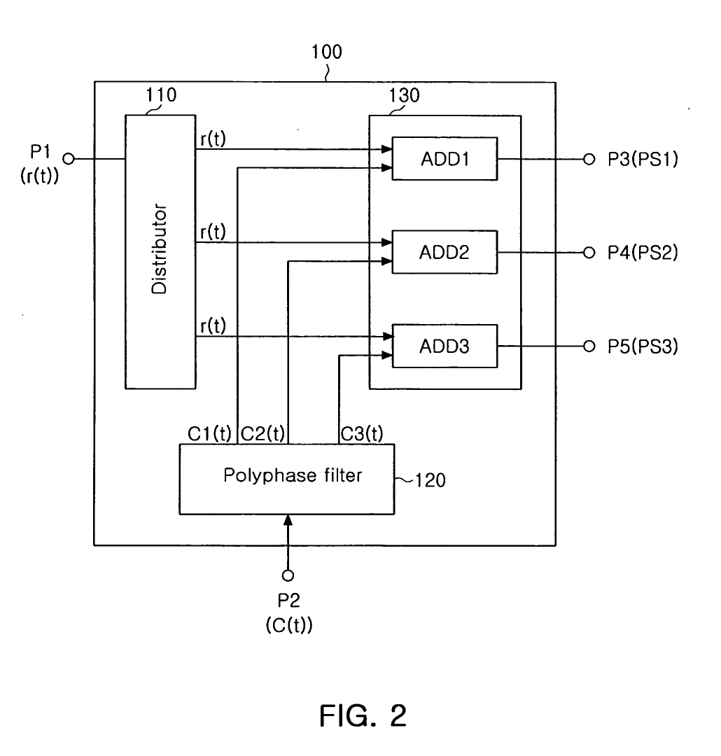

FIG. 2 is an internal configuration view illustrating a five-port network according to an exemplary embodiment of the invention.

Referring to FIG. 2, the five-port network 100 includes a distributor 110, a polyphase filter 120 and a multiple adder 130. The distributor 110 distributes the input signal as the three signals. The polyphase filter 120 phase-shifts a carrier signal (c(t)) differently from one another to generate the first, second and third carrier signals (c1(t)), (c2(t)), and (c3(t)) having different phases. The multiple adder 130 adds the three signals from the distributor 110 to the first, second and third carrier signals (c1(t)), (c2(t)), and (c3(t)) from the polyphase filter 120, respectively to output the first, second and third phase signals (PS1), (PS2), and (PS3) having phases different from one another.

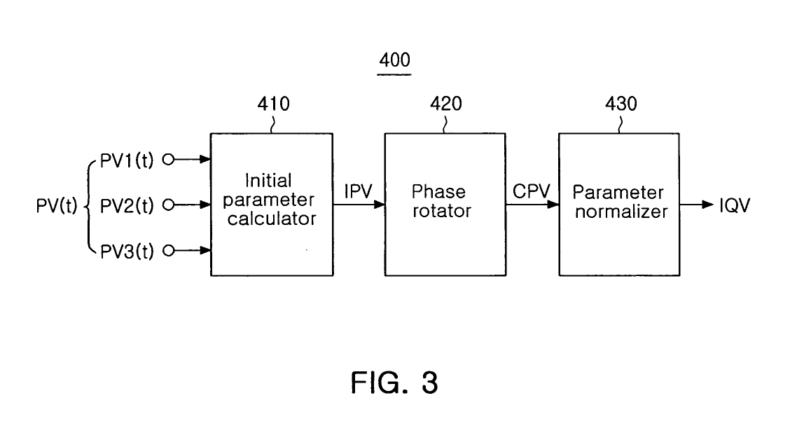

FIG. 3 is an internal configuration view illustrating a post-processing part according to an exemplary embodiment of the invention.

Referring to FIG. 3, the post-processing part 400 includes an initial parameter calculator 410, a phase rotator 420 and a parameter normalizer 430. The initial parameter calculator 410 calculates initial I/Q regeneration parameters IPV using phase shift of I/Q signals regenerated from the first, second and third power detection signals (PDV1), (PDV2), and (PDV3) from the power detection part 200. The phase rotator 420 phase-corrects the I/Q regeneration parameters IPV from the initial parameter calculator 410 to calculate corrected I/Q regeneration parameters CPV. The parameter normalizer 430 normalizes the corrected I/Q regeneration parameters CPV from the phase rotator 420 to calculate final I/Q regeneration parameters IQV.

The initial parameter calculator 410 divides each of the I/Q signals regenerated from the first, second and third power detection signals (PDV1), (PDV2), and (PDV3) from the power detection part into two factors Φ and Φ+π according to phase shift, and calculates the initial I/Q regeneration parameters IPV so that direct current (DC) offset is eliminated from the two factors Φ and Φ+π.

The phase rotator 420 phase-corrects the initial I/Q regeneration parameters using the I/Q regeneration parameter IPV from the initial parameter calculator 410 such that a long axis of an elliptical trajectory, i.e., locus defined by the I/Q signals regenerated coincides with an X axis, and calculates the corrected I/Q regenerated parameters CPV.

The parameter normalizer 439 scales regeneration parameters for one of an I value signal and a Q value signal out of the corrected I/Q regeneration parameters CPV from the phase rotator 420 and normalizes the regeneration parameters such that an I value has a maximum size identical to a maximum size of a Q value.

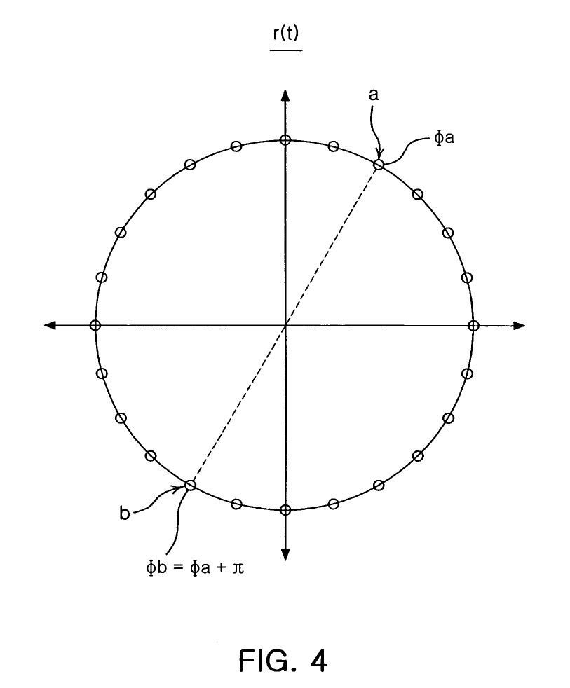

FIG. 4 is a locus diagram of a received signal (r(t)) inputted to the five-port network 100 of the present invention. In this diagram, in a case where a point “a” is denoted with “Φa”, a point “b” which is 180 degrees out of phase with the “a” point is denoted with “Φ+π=Φb”.

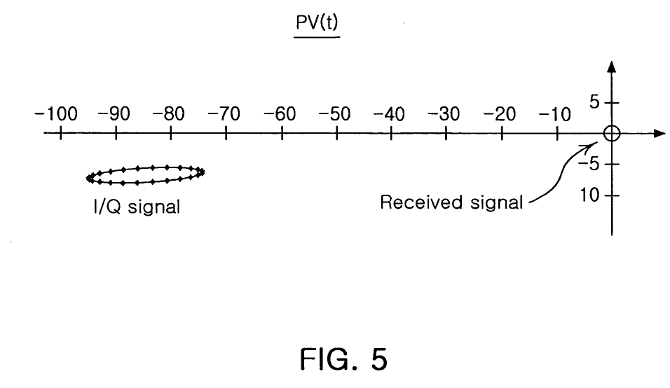

FIG. 5 is a trajectory, i.e., locus diagram of a received signal inputted to a post-processing part and I/Q signals regenerated from the uninitialized I/Q regeneration parameters. Compared with the received signal, the I/Q signals each have DC offset and are distorted.

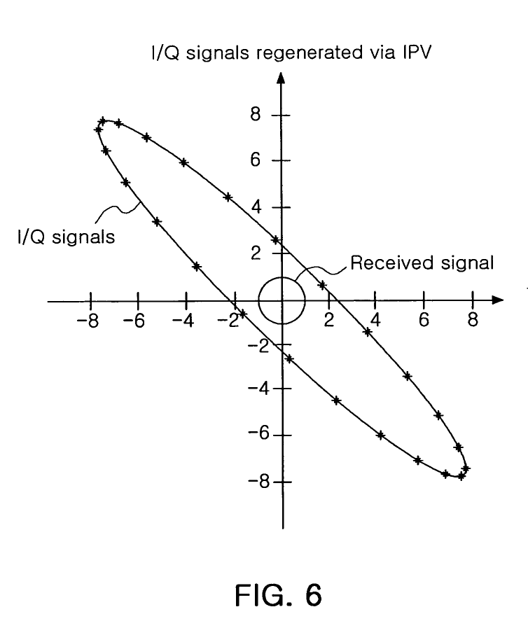

FIG. 6 is a locus diagram of I/Q signals regenerated by an initial I/Q regeneration parameters calculated by an initial parameter calculator. Referring to FIG. 6, the DC offset has been eliminated from the I/Q signals regenerated by the initial I/Q regeneration parameters outputted from the initial parameter calculator but the I/Q signals define a distorted elliptical locus unlike the locus diagram of FIG. 4.

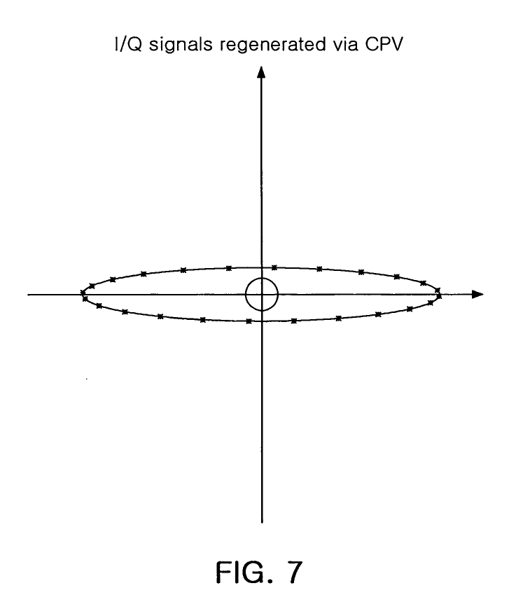

FIG. 7 is a locus diagram of I/Q signals regenerated by corrected I/Q regeneration parameters corrected by a phase rotator. In FIG. 7, the I/Q signals regenerated by the corrected I/Q regeneration parameters outputted from the phase rotator maintain an elliptical locus whose long axis, however, coincides with an X axis.

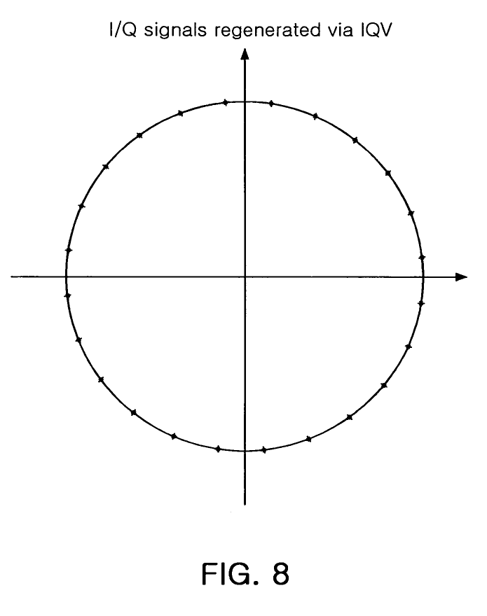

FIG. 8 is a locus diagram of I/Q signals regenerated by I/Q regeneration parameters finally corrected by a parameter normalizer. In FIG. 8, final I/Q regeneration parameters outputted from the parameter normalizer are identical in size.

Hereinafter, operation and effects will be described in detail with reference to the drawings attached.

An I/Q regeneration device of a five-port network will be described with reference to FIGS. 1 to 8. First, FIG. 1 illustrates a structure of a receiver for estimating I/Q regeneration parameters to perform data demodulation of a five-port receiver using a received signal (r(t)) of a single-frequency continuous wave.

Referring to FIG. 1, the I/Q regeneration device of the five-port network of the present embodiment includes a five-port network 100, a power detection part 200, a filter part 300 and a post-processing part 400.

The five-port network 100 distributes an input signal (r(t)) as three signals and adds the three signals to first, second and third carrier signals (c1(t)), (c2(t)), and (c3(t)), respectively to output first, second and third phase signals having phases (PS1), (PS2), and (PS3) different from one another.

In the locus diagram of FIG. 4 showing a locus of a received signal (r(t)) inputted to the five-port network 100, in a case where a point “a” is denoted with “Φa”, a point “b” which is 180 degrees out of phase with the point “a” is denoted with “Φ+π=Φb”. Accordingly, the five-port network 100 is capable of recognizing one point and another point which is 180 degrees out of phase with the point in the received signal (r(t))as shown in FIG. 4.

The five-port network 100 will be described in detail with reference to FIG. 2.

Referring to FIG. 2, the five-port network 100 includes a distributor 110, a polyphase filter 120 and a multiple adder 130.

The distributor 110 distributes an input signal (r(t)) as three signals.

The polyphase filter 120 phase-shifts a carrier signal (c(t)) differently from one another to generate first, second and third carrier signals (c1(t)), (c2(t)), and (c3(t)) having different phases.

The multiple adder 130 adds the three signals from the distributor 110 to the first, second and third carrier signals (c1(t)), (c2(t)), and (c3(t)) from the polyphase filter 120, respectively to output first, second and third phase signals (PS1), (PS2), and (PS3) having different phases.

Referring back to FIG. 1, the power detection part 200 detects power of each of the first, second and third phase signals (PS1), (PS2), and (PS3) from the five-port network 100 to output first, second and third power detection signals to the filter part 300. The filter part 300 passes the first, second and third power detection signals from the power detection part to the post-processing part 400 and blocks noise except the first, second and third power detection signals.

Also, referring to FIG. 1, the post-processing part 400 recovers original data in response to the first, second and third power detection signals (PDV1), (PDV2), and (PDV3) from the power detection part 200.

Referring to FIGS. 1 and 5, when I/Q signals inputted to the post-processing part 400 are compared with a received signal, the I/Q signals each have DC offset and are distorted, and the DC offset and distortion may be eliminated by the post-processing part 400.

That is, the I/Q signals define not a circular locus as shown in FIG. 4 but an elliptical locus as shown in FIG. 5. Here, the received signal also contains DC offset components.

The post-processing part 400 will be described in detail with reference to FIG. 3.

Referring to FIG. 3, the post-processing part 400 includes an initial parameter calculator 410, a phase rotator 420 and a parameter normalizer 430.

Referring to FIGS. 1, 3 and 6, the initial parameter calculator 410 calculates initial I/Q regeneration parameters IPV using phase shift of the I/Q signals regenerated from the first, second and third power detection signals (PDV1), (PDV2), and (PDV3) from the power detection part 200.

The initial parameter calculator 410 divides each of the I/Q signals regenerated from the first, second and third power detection signals (PDV1), (PDV2), and (PDV3) from the power detection part 200 into two factors Φa and Φa+π according to phase shift, and calculates the initial I/Q regeneration parameters IPV such that DC offset is eliminated from the two factors Φa and Φa+π.

That is, the post-processing part 400 regenerates the first, second and third power detection signals (PDV1), (PDV2), and (PDV3) from the power detection part 200 into the respective I/Q signals according to following equation 1:

Iᵣ(t)=A_{I1}P₁(t)+A_{I2}P₂(t)+A_{I3}P₃(t)

Qᵣ(t)=A_{Q1}P₁(t)+A_{Q2}P₂(t)+A_{Q3}P₃(t) equation 1

In the above equation 1, A_{I1}, A_{I2}, A_{I3}, A_{Q1}, A_{Q2}, A_{Q3} are the I/Q regeneration parameters, P₁, P₂ and P₃ are the first, second and third power signals PDV1, PDV2, and PDV3 from the power detection part 200.

Meanwhile, referring to FIG. 4, in the received signal of single-frequency continuous wave, a signal with a Φa phase and a signal with Φa+π phase each include a real signal component and an imaginary signal component, and are identical in size but opposite in polarities.

Therefore, the first, second and third power detection signals (PDV1), (PDV2), and (PDV3) from the power detection part 200 are applied to the above equation 1 to be expressed as an I regeneration signal and a Q regeneration signal having a phase difference of p from each other according to equation 2.

Iᵣ(t)C_{Φ(t)=Φa}=A_{I1}P₁(t)C_{Φ(t)=Φa}+A_{I2}P₂(t)C_{Φ(t)=Φa}+A_{I3}P₃(t)C_{101 (t)=Φa}

Iᵣ(t)C_{Φ(t)=Φa+π}=A_{I1}P₁(t)C_{Φ(t)=Φa+π}A_{I2}P₂(t)C_{Φ(t)=Φa+π}+A_{I3}P₃(t)C_{Φ(t)=Φa+π}

Qᵣ(t)C_{Φ(t)=Φa}=A_{Q1}P₁(t)C_{Φ(t)=Φa}=A_{Q2}P₂(t)C_{Φ(t)=Φa}=A_{Q3}P₃(t)C_{Φ(t)=Φa}

Qᵣ(t)C_{Φ(t)=Φa+π}=A_{Q1}P₁(t)C_{Φ(t)=Φa+π}+A_{Q2}P₂(t)C_{Φ(t)=Φa+π}+A_{Q3}P₃(t)C_{Φ(t)=Φa+π} equation 2

In the above equation 2, to remove the DC offset, the initial I/Q regeneration parameters can be set such that a sum of I values is “0” and a sum of Q values is “0.” When determining the initial I/Q regeneration parameters, one of A_{I1} to A_{I3} can be expressed with the other parameters. Also, one of A_{Q1} to A_{Q3} can be expressed with the other parameters. For example, A_{I3} and A_{Q3} are represented by following equation 3.

$${A}_{I 3} = \frac{\begin{matrix}{A}_{I 1} ( {p}_{1} ( t ) {c}_{Φ ( t ) = Φ a} + {P}_{1} ( t ) {c}_{Φ ( t ) = Φ a + π} ) + \\ {A}_{I 2} ( {p}_{2} ( t ) {c}_{Φ ( t ) = Φ a} + {P}_{2} ( t ) {c}_{Φ ( t ) = Φ a + π} ) +\end{matrix}}{{P}_{3} ( t ) {c}_{Φ ( t ) = Φ a} + {P}_{3} ( t ) {c}_{Φ ( t ) = Φ a + π}} \\ {A}_{Q 3} = \frac{\begin{matrix}{A}_{Q 1} ( {p}_{1} ( t ) {c}_{Φ ( t ) = Φ a} + {P}_{1} ( t ) {c}_{Φ ( t ) = Φ a + π} ) + \\ {A}_{Q 2} ( {p}_{2} ( t ) {c}_{Φ ( t ) = Φ a} + {P}_{2} ( t ) {c}_{Φ ( t ) = Φ a + π} ) +\end{matrix}}{{P}_{3} ( t ) {c}_{Φ ( t ) = ϕ a} + {P}_{3} ( t ) {c}_{Φ ( t ) = Φ a + π}} \qquad equation 3$$

After performing the initial I/Q regeneration parameter calculation as described above, the DC offset is eliminated, as shown in FIG. 6.

Referring to FIG. 6, the I/Q signals regenerated by the initial I/Q regeneration parameters outputted from the initial parameter calculator define an elliptical locus, in which the received signal is free from the DC offset. When the I/Q signals are passed through the phase rotator 420, the I/Q signals regenerated as shown in FIG. 7 maintain an elliptical locus whose long axis, however, coincides with a X axis.

Referring to FIGS. 1, 2 and 7, the phase rotator 420 phase-corrects the initial I/Q regeneration parameters IPV from the initial parameter calculator 410 to calculate corrected I/Q generation parameters CPV.

The phase rotator 420 phase-corrects the initial I/Q regeneration parameters using the I/Q regeneration parameters IPV from the initial parameter calculator 410 such that a long axis of an elliptical locus defined by the I/Q signals regenerated coincides with an X axis, and calculates the corrected I/Q regeneration parameters CPV.

Referring to FIG. 7, the I/Q signals regenerated by the corrected I/Q regeneration parameters outputted from the phase rotator 420 maintain the elliptical locus whose long axis, however, coincides with an X axis.

That is, the phase rotator 420 allows central axes of the elliptical locus to coincide with the x axis and y axis, respectively. Here, to increase speed of phase rotation, a least mean square (LMS) technique may be employed.

Moreover, referring to FIGS. 1, 3 and 8, the parameter normalizer 430 scales regeneration parameters for one of an I value signal and a Q value signal out of the corrected I/Q regeneration parameters CPV from the phase rotator 420 and normalizes the regeneration parameters such that an I value has a maximum size identical to a maximum size of a Q value.

Referring to FIG. 8, final I/Q regeneration parameters outputted from the parameter normalizer 430 are identical in size. That is, scaling of regeneration parameters of one of the I phase and quadrature phase, as shown in FIG. 8, produces normalized final I/Q regeneration parameters as shown in FIG. 8.

In the present embodiment described above, in performing parameter estimation for I/Q regeneration using the five-port network, the I/Q regeneration device of a novel structure receives a signal and regenerates the received signal into I/Q signals by employing the five-port network in an orthogonal frequency division multiplexing (OFDM) or continuous phase modulation (CPM) signal even without utilizing a modulated signal, particularly, a quadrature phase-shift keying (QPSK) modulated signal. This I/Q regeneration device overcomes conventional problems and performs quick estimation of I/Q regeneration parameters of the five-port network.

As set forth above, according to exemplary embodiments of the invention, in an I/Q regeneration device of a five-port network applicable to a demodulator such as a receiver, a single-frequency continuous wave signal is utilized in place of a specific modulated signal such as a QPSK signal to estimate I/Q regeneration parameters of the five-port network, thereby shortening estimation time of the I/Q regeneration parameters, expanding a range of applicable telecommunication systems and enabling demodulation using the five-port network.

While the present invention has been shown and described in connection with the exemplary embodiments, it will be apparent to those skilled in the art that modifications and variations can be made without departing from the spirit and scope of the invention as defined by the appended claims.

What is claimed is:

1. An I/Q regeneration device of a five-port network comprising:
a five-port network distributing an input signal as three signals and adding the three signals to first, second and third carrier signals, respectively to output first, second and third phase signals each having a phase different from one another;
a power detection part detecting a power of each of the first, second and third phase signals from the five-port network to output first, second and third power detection signals; and
a post-processing part restoring original data in response to the first, second and third power detection signals.

2. The I/Q regeneration device of claim 1, further comprising:
a filter part passing the first, second and third power detection signals therethrough and blocking noise except the first, second and third power detection signals.

3. The I/Q regeneration device of claim 1, wherein the five-port network comprises:
a distributor distributing the input signal as the three signals;
a polyphase filter phase-shifting a carrier signal differently from one another to generate the first, second and third carrier signals having different phases; and
a multiple adder adding the three signals from the distributor to the first, second and third carrier signals from the polyphase filter, respectively to output the first, second and third phase signals having different phases.

4. The I/Q regeneration device of claim 1, wherein the post-processing part comprises:
an initial parameter calculator calculating an initial I/Q regeneration parameter using phase shift of I/Q signals regenerated from the first, second and third power detection signals;
a phase rotator phase-correcting the I/Q regeneration parameter from the initial parameter calculator to calculate a corrected I/Q regeneration parameter; and
a parameter normalizer normalizing the corrected I/Q regeneration parameter from the phase rotator to calculate a final I/Q regeneration parameter.

5. The I/Q regeneration device of claim 4, wherein the initial parameter calculator divides each of the I/Q signals regenerated from the first, second and third power detection signals into two factors according to phase shift, and calculates the initial I/Q regeneration parameter such that direct current offset is eliminated from the two factors.

6. The I/Q regeneration device of claim 4, wherein the phase rotator phase-corrects the initial I/Q regeneration parameter using the I/Q regeneration parameter from the initial parameter calculator such that a long axis of an elliptical locus defined by the I/Q signals regenerated coincides with an X axis, and calculates the corrected I/Q regeneration parameter.

7. The I/Q regeneration device of claim 4, wherein the parameter normalizer scales a regeneration parameter for one of an I value signal and a Q value signal out of the corrected I/Q regeneration parameter from the phase rotator and normalizes the regeneration parameter such that an I value has a maximum size identical to a maximum size of a Q value.
